(19) United States
(12) Patent Application Publication
(10) Pub. No.: US 2010/0333133 A1
(43) Pub. Date: Dec. 30, 2010

(54) SYSTEMS AND METHODS FOR MEDIA GUIDANCE APPLICATIONS FOR BROWSING VIDEO-ON-DEMAND LISTINGS

(76) Inventors: Haig Krakirian, Burbank, CA (US); Geoff Ombao, Pacific Palisades, CA (US); Glen E. Roe, Simi Valley, CA (US)

Correspondence Address: ROPES & GRAY LLP, PATENT DOCKETING 39/361, 1211 AVENUE OF THE AMERICAS, NEW YORK, NY, 10036-8704, US

(21) Appl. No.: 12/495,527

(22) Filed: Jun. 30, 2009

(51) Int. Cl. H04N 7/10; H04N 7/173

(52) U.S. Cl. 725/32; 725/87

(57) ABSTRACT

Systems and methods for media guidance application for browsing and displaying video-on-demand listings are described. A user interacting with the media guidance application may select or highlight a channel in the program listings grid guide. The user may then view, browse, and select video-on-demand listings that relate to the selected channel on the program listing grid display. The video-on-demand listings may be retrieved from a storage device in the media guidance equipment. In an embodiment, the video-on-demand listings comprise a partial or full list of on-demand listings for the selected channel. In an embodiment, the video-on-demand listings comprise a list of the most popular on-demand listings related to the selected channel.

### SUMMARY OF THE INVENTION

The present invention relates to interactive media guidance application systems and methods that provide for improved browsing and display of video-on-demand (VOD) listings or offerings, e.g., on-demand movies, television programs, video clips, audio clips, or any other suitable type of media.

It is therefore an object of the present disclosure to provide improved browsing and displaying of VOD listings or offerings. This and other objects of the present invention are accomplished in accordance with principles of the present invention that relate to interactive media guidance application systems and methods that provide for the browsing and displaying of video-on-demand (VOD) listings. While embodiments will be described herein with reference to interactive media guidance applications, the systems and methods described herein may be applicable to any media viewing system providing for the display of media listings related to media content based on a user's selection of the media content.

The media guidance application systems and methods described herein in various embodiments allow a user interacting with an interactive media guidance application implemented on media guidance equipment to select or highlight a cell in the program listings grid guide, then to view, browse, and select video-on-demand listings that relate to the selected cell on the program listing grid display. In an embodiment, the interactive media guidance application may be configured to receive a user selection of a cell in a program listings grid in a first region of the interactive display, and to generate video-on-demand listings related to the selected cell based on the received user input. The metadata associated with the available video-on-demand listings, and the metadata associated with the selected cell, may be stored in data structures in one or more storage devices on the media guidance equipment. In an embodiment, the video-on-demand listings may be generated by correlating metadata related to the selected cell in a selected cell data structure stored in a storage device in the media guidance equipment to metadata in a video-on-demand listings data structure stored in a storage device in the media guidance equipment. This association may be performed by using a pointer from the selected cell data structure to the video-on-demand listings data structure.

In an embodiment, the generated video-on-demand listings may include one or more video-on-demand listings for the channel corresponding to the selected cell. The generated video-on-demand listings may include the highest rated or most popular video-on-demand listings related to the content of the program listing in the selected cell. In certain embodiments, the generated video-on-demand listings include the most viewed video-on-demand listings related to the content of the program listing in the selected cell. The metadata associated with the video-on-demand content related to a program listing, and the metadata associated with the program listing itself, may be stored in data structures in one or more storage devices on the media guidance equipment.

In an embodiment, user preferences for the interactive media guidance application may be retrieved from media guidance equipment, and the video-on-demand listings may be generated based in part on the retrieved user preferences. The user preferences may include at least one of displaying video-on-demand listings related to a channel corresponding to the selected cell, displaying video-on-demand listings related to the content of a program listing in the selected cell, displaying the highest rated video-on-demand listings related to the content of a program listing in the selected cell, and displaying the most viewed video-on-demand listings related to the content of a program listing in the selected cell. The user may select these preferences by interacting with a user preference display on the interactive media guidance application.

In an embodiment, the user preferences are stored on the media guidance equipment by allowing the user to input the user preferences when interacting with the media guidance application. In an embodiment, the user preferences are stored on the media guidance equipment by having the media guidance application monitor the user interactions with the interactive media guidance application to determine one or more of the user preferences.

In an embodiment, the generated video-on-demand listings are displayed in a second region of the interactive display, from which the user may select one of the video-on-demand listings for viewing. The selected video-on-demand listing may be displayed on the interactive display.

### BRIEF DESCRIPTION OF THE DRAWINGS

The detailed description of certain illustrative embodiments of the present invention below refers to the accompanying drawings, of which:

FIG. 1 shows an illustrative grid program listings display for an interactive media guidance application;

FIG. 2 shows another illustrative grid program listings display for an interactive media guidance application;

FIG. 3 shows a generalized embodiment of illustrative user equipment device that may be used to display grid program listings and video-on-demand listings;

FIG. 4 shows more specific implementations of user equipment devices that may be used to display grid program listings and video-on-demand listings;

FIG. 5 is an illustrative grid program listings display with an additional display for an interactive media guidance application;

FIG. 6 shows a data structure that may be used to store information (e.g., metadata and pointers) corresponding to a grid program listing;

FIG. 7 shows a data structure that may be used to store information (e.g., metadata and pointers) corresponding to available video-on-demand listings;

FIGS. 8A and 8B show illustrative interactive displays for entering user preferences related to video-on-demand listings in an interactive media guidance application;

FIG. 9 shows an illustrative grid program listings and video-on-demand listings display for an interactive media guidance application according to an embodiment;

FIG. 10A shows an illustrative second grid program listings and video-on-demand listings display for an interactive media guidance application according to an embodiment;

FIG. 10B shows an illustrative grid program listings and video-on-demand listings display for an interactive media guidance application according to an embodiment;

FIG. 11 is a process flow diagram for the display of video-on-demand listings according to an illustrative embodiment;

FIG. 12 is a process flow diagram for the retrieval of user preferences pertaining to the display of video-on-demand listings according to an illustrative embodiment, and

FIG. 13 is a decision tree diagram for the processing of a user selection of a cell in a program listings grid according to an illustrative embodiment.

### DETAILED DESCRIPTION OF CERTAIN ILLUSTRATIVE EMBODIMENTS

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, media-on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc.

The interactive media guidance application may provide a display screen with media information organized in one of several ways, such as by time and channel in cells in a program listings grid, by time, by channel, by media type, by category (e.g., movies, sports, news, children, or other categories of programming) in a program listings grid, or other predefined, user-defined, or other organization criteria. The media guidance application may be implemented on media guidance equipment.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a set-top box based electronic programmable guide. Consequently, media guidance is necessary on these devices, as well. The guidance provided may be for media content available through a television, for media content available through one or more of these devices, or both. The media guidance applications may be provided as on-line applications (i.e., provided on a web-site), or as stand-alone applications or clients on hand-held computers, PDAs, mobile telephones, or other mobile devices.

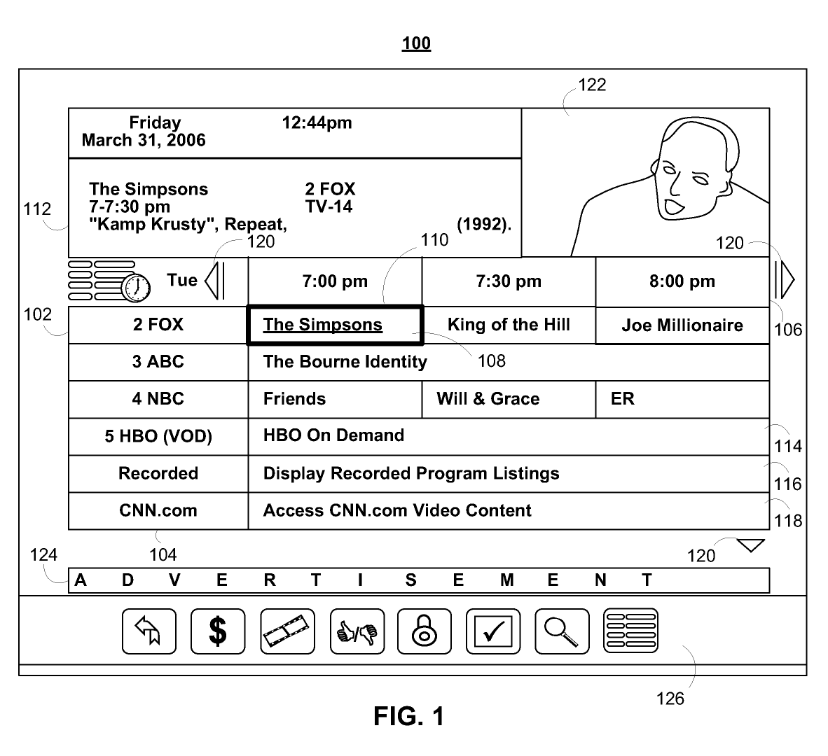

One of the functions of an interactive media guidance application is to provide media listings and media information to users. The various devices and platforms that may implement media guidance applications are described in more detail below. FIGS. 1, 2, 5, 8A, 8B, 9, 10A and 10B show illustrative display screens that may be used to provide media guidance, and in particular media listings. The display screens shown in FIGS. 1, 2, 5, 8A, 8B, 9, 10A and 10B may be implemented on any suitable device or platform. While the displays of FIGS. 1, 2, 5, 8A, 8B, 9, 10A and 10B are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

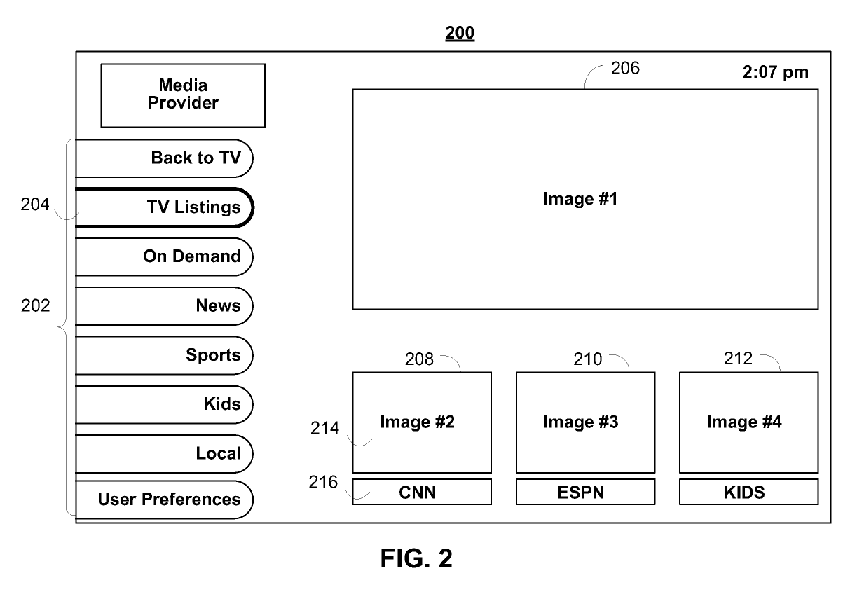

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Systems and methods for displaying on-demand listings, including video-on-demand offerings, are described further in McCoy et al., U.S. patent application Ser. No. 10/892,002, filed Jul. 22, 2004, the contents of which are incorporated herein in their entirety. Internet content may include web events, such as a chat session or Webcast, or content available on-demand as streaming media or downloadable media through an Internet web site or other Internet access (e.g. FTP). Non-linear programming is described further in relation to FIGS. 2, 5, 9, 10A and 10B below.

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In an embodiment, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video (or any other suitable media) region 122, advertisement region 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement region 124 may provide an advertisement for media content that, depending on a viewer's access rights (e.g., for subscription programming), is currently available for viewing, will be available for viewing in the future, or may never become available for viewing. For example, a viewer may have access to media content related to a news program in grid 102, and these media content may be displayed in advertisement region 124. Further, a viewer may not have access to an “HBO” special that is displayed in advertisement region 124. A viewer may or may not have access to this HBO special depending on their subscription programming access rights. In an embodiment, the media content may be related to unrelated to one or more of the media listings in grid 102, e.g., an advertisement for men's razor blades may be displayed if one of the media listings in grid 102 is titled “Monday Night Football at Gillette Stadium”. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on user profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, access to various types of listing displays, subscribe to a premium service, edit a user profile, edit user preferences, access a browse overlay, or other options.

The media guidance application may be personalized based on user preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile, which may be customized for each user who will be interacting with the media guidance application. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations. For instance, a user may be able to select the type of display 150 that is to be generated by the media guidance application. This selection may be made in terms of features of the display 150, e.g., number of advertisements, number of rows of grid 102, number of columns of grid 102, content that should or should not be displayed in regions 121, 122, and 123 of the display 150, the size of the text and/or media displayed in display 100, or any other suitable feature of display 100.

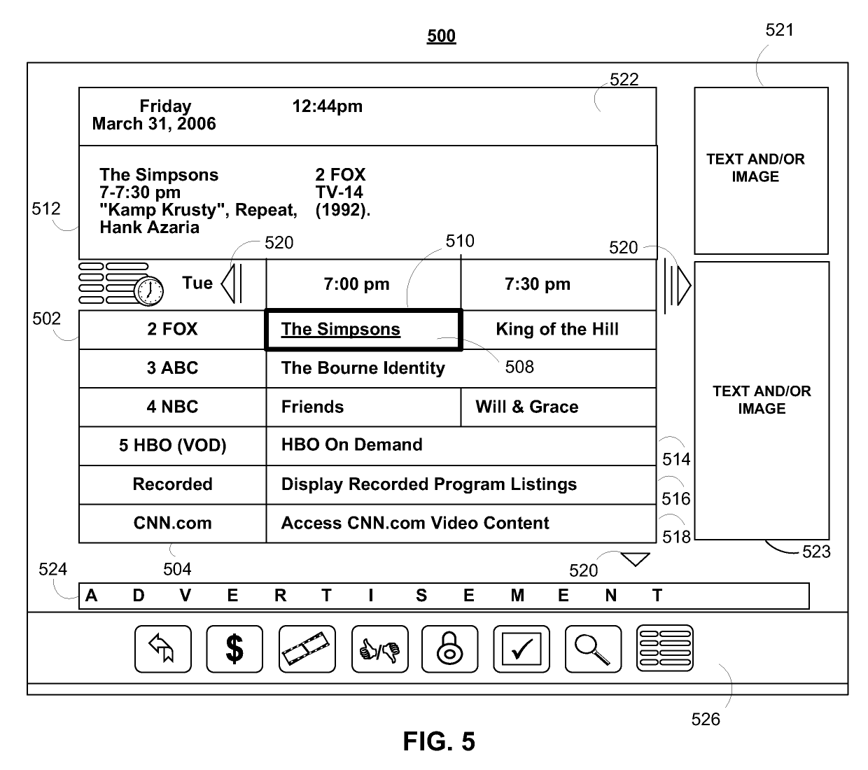

The media guidance application may allow a user to provide user profile information or may automatically compile user profile information. The media guidance application may, for example, monitor the media the user accesses and/or other interactions the user may have with the media guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, Ellis et al., U.S. patent application Ser. No. 10/105,128, filed Feb. 21, 2002, and Knudson, U.S. patent application Ser. No. 11/823,421, filed Jun. 27, 2007, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicate to a user the media content being described by the listing. Each of the graphical listings may also be accompanied by text to provide further information about the media content associated with the listing. For example, listing 208 may include more than one region, including media region 214 and text region 216. Media region 214 and/or text region 216 may be selectable to view video in full-screen or to view program listings related to the video displayed in media region 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

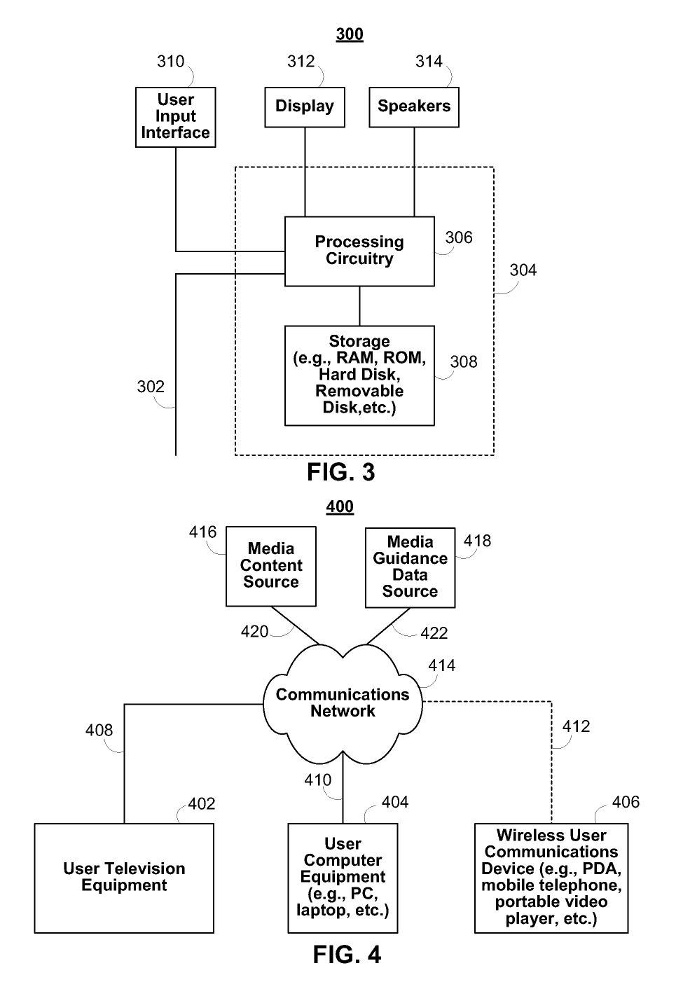

FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

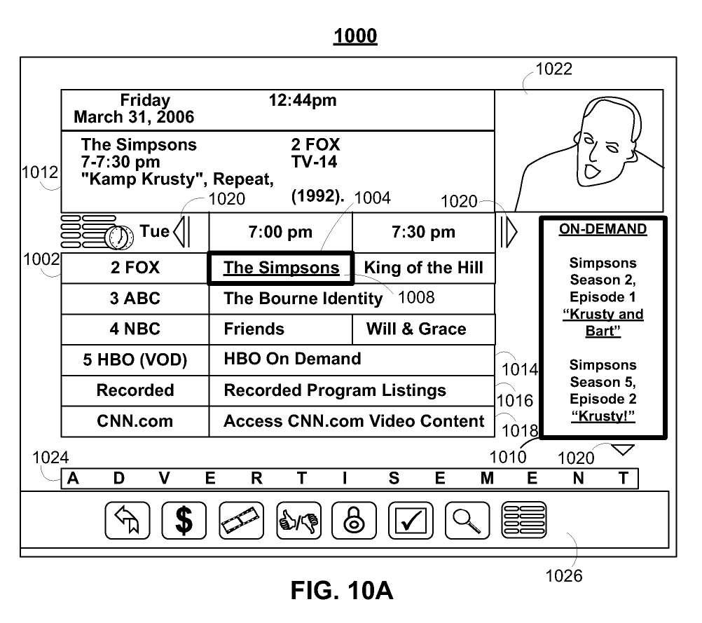

Control circuitry 304 may be based on any suitable processing circuitry 306 such as processing circuitry based on one or more microprocessors, microcontrollers, digital signal processors, programmable logic devices, etc. In an embodiment, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 9). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, a user's preferences or user's profile information, or other data used in operating the guidance application. Nonvolatile memory may also be used (e.g., to launch a boot-up routine and other instructions). Storage 308 may be used to store various types of information on the user preferences and VOD listings discussed with respect to FIGS. 4, 6, and 7.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface or device 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In an embodiment, display 312 may be HDTV-capable. Speakers 314 may be provided as integrated with other elements of user equipment device 300 or may be stand-alone units. The audio component of videos and other media content displayed on display 312 may be played through speakers 314. In an embodiment, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from the VBI of a television channel, from an out-of-band feed, or using another suitable approach). In another embodiment, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In yet another embodiment, the media guidance application is downloaded and interpreted or otherwise run by an interpreter or virtual machine (run by control circuitry 304). In an embodiment, the guidance application may be encoded in the ETV Binary Interchange Format (EBIF), received by control circuitry 304 as part of a suitable feed, and interpreted by a user agent running on control circuitry 304. For example, the guidance application may be a EBIF widget. In an embodiment, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in an embodiment, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In an embodiment, the guidance application may be a stand-alone interactive television program guide that receives program guide data via a data feed (e.g., a continuous feed, trickle feed, or data in the vertical blanking interval of a channel).

Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In an embodiment, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

Users may access media content and the media guidance application (and its display screens described in reference to FIGS. 1, 2, 5, 8A-B, 9, and 10A-B above and below) from one or more of their user equipment devices or media guidance equipment.

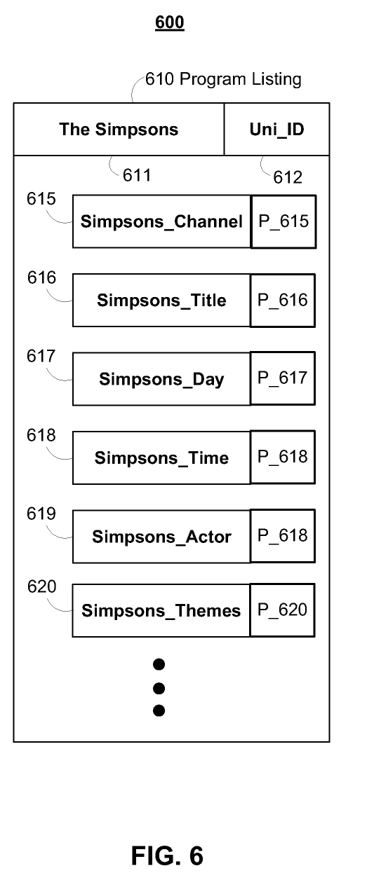

Illustrative embodiments of the present invention will be described further in relation to FIGS. 5-12.

FIG. 5 shows an illustrative embodiment of a display 500 that may be generated by a media guidance application. Display 500 may be generated on display 312 of media guidance equipment 300 (FIG. 3) in conjunction with processing circuitry 306 (FIG. 3). Display 500 may be interactive and may include grid program listings display arranged by time and channel that also enables access to different types of media content in a single display. For instance, display 500 may include grid 502 with: a column of channel/media type identifiers, where each channel/media type identifier (which is a cell in the column) identifies a different channel or media type available; and a row of time identifiers 506, where each time identifier (which is a cell in the row) identifies a time block of programming. Grid 502 also includes cells of program listings, such as program listing 508 (“The Simpsons”), where each listing provides the title of the program provided on the listing's associated channel and time. With a user input device, a user can select program listings by moving highlight region 510. As described above in relation to FIG. 1, information relating to the program listing selection in region 510 (corresponding to cell 508) may be provided in program information region 512. Options region 526 operates as described in relation to options region 126 in FIG. 1 above.

In addition to providing access to linear programming provided according to a schedule, the media guidance application also provides access to non-linear programming which is not provided according to a schedule. For instance, grid 502 may provide listings for non-linear programming including on-demand listing 514, recorded media listing 516, and Internet content listing 518. As illustrated, listings 514, 516, and 518 are shown as spanning the entire time block displayed in grid 502 to indicate that selection of these listings may provide access to a display dedicated to on-demand listings, recorded listings, or Internet listings, respectively. In an embodiment, listings for these media types may be included directly in grid 502, or may be displayed as text and/or images and/or video in regions 521 and/or 523 of display 500. Additional listings may be displayed in response to the user selecting one of the navigational icons 520 using a user interface or device.

Display 500 may also include regions 521, 522 and 523 for displaying video, and/or text, and/or image data, advertisement region 524, and options region 526. Regions 522 and 523 may allow the user to view and/or preview programs that are currently available, will be available, or were available to the user. The size, shape, and location of regions 522 and 523 shown in display 500 are for illustrative purposes only. Any suitable size, shape, or location on display 500 may be used for the regions 522 and 523.

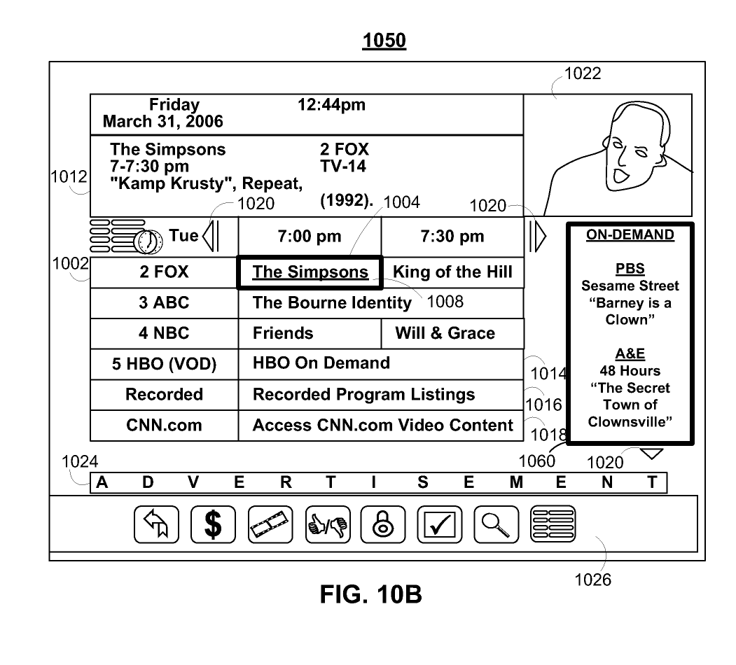

The content of regions 522 and 523 may correspond to, or be independent from, one of the listings displayed in grid 502, e.g., region 522 may contain information corresponding to the listing for “The Simpsons” 508 in highlighted or selected region 510. The region 510 may be highlighted or selected because a user interacting with the interactive display has selected the cell containing the “The Simpsons” listing. As will be described further in relation to FIGS. 9, 10A, and 10B, region 523 may be used to display video-on-demand listings, or other non-linear program listings, that are related to a selected cell 510 of grid 502, and that are based on user preferences.

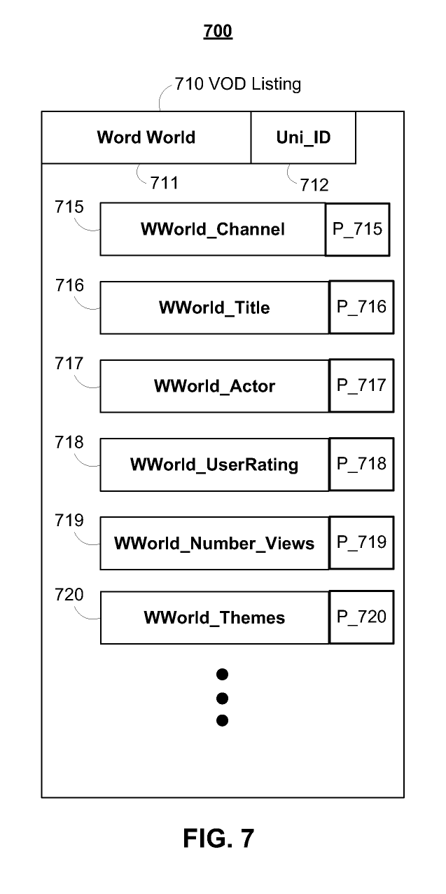

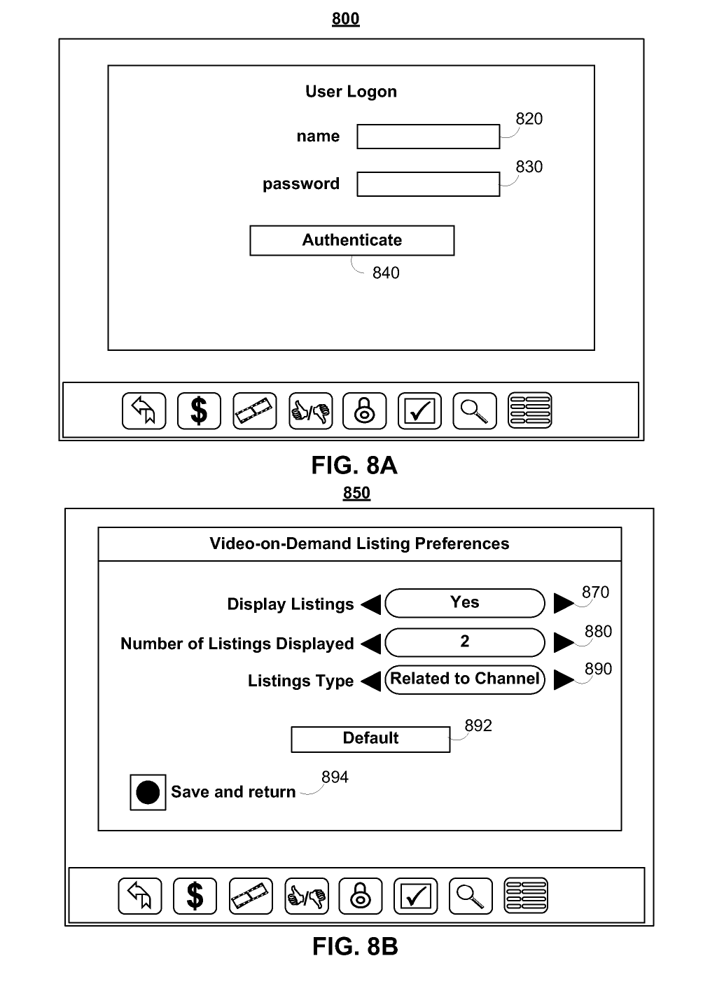

FIG. 6 shows a data structure 600 that may be used to store information, e.g., metadata and pointers, corresponding to a selected cell, e.g., cell or region 510 in display 500 (FIG. 5) in a grid program listing in accordance with an illustrative embodiment. Data structure 600 may be stored in a storage device such as storage 308 (FIG. 3) in media guidance equipment 300 (FIG. 3). The metadata and pointers in data structure 600 may be correlated with video-on-demand listings metadata and pointers as will be described below in relation to FIGS. 7 and 9-12.

Data structure 600 may be provided by media content source 416. Additionally, or alternatively, data structure 600 may be generated as required by processing circuitry 306 (FIG. 3), e.g., processing circuitry 306 (FIG. 3) may generate data structure 600 by retrieving and processing data stored in storage 308 (FIG. 3). Additionally, or alternatively, data structure 600 may be provided by media guidance data source 418 in media guidance system 400 (FIG. 4). In an embodiment, the cable system headend may be media content source 416 and may provide a data structure associated with each cable television program sent to the user media equipment and/or the interactive media guidance application. This data structure may be stored on storage 308 (FIG. 3). At an appropriate time, the data structure may then be retrieved from storage and associated with a cell in the interactive media guidance application program guide listings grid by processing circuitry 306 (FIG. 3). In an embodiment, the media guidance data source 418 may provide the a data structure associated with each media listing, and this data structure may be stored on storage 308 (FIG. 3). At an appropriate time, e.g., when the media listing is displayed in an interactive display by the interactive media guidance application, the data structure may then be retrieved from storage and associated with a cell in the interactive media guidance application program guide listings grid by processing circuitry 306 (FIG. 3).

Cell data structure 600 may include alphanumeric identifiers 610 and 612. For example, for the episode of “The Simpsons” in the selected cell 510 in display 500 (FIG. 5), the identifier 610 may be “Simpsons”, while the identifier 612 may be the number 134576, or any other suitable alphanumeric identifier. In an embodiment, identifier 612 is unique such that the metadata in data structure 600 may be uniquely identified and uniquely associated with a program listing, while identifier 610 may not be unique. The user of a unique identifier allows for the differentiation between different program grid listings. Data structure 600 also includes metadata at locations 615-619 corresponding to the channel, title, day, time, an actor, and a theme in the program listing in the selected cell. For example, metadata location 615 may correspond to the channel, e.g., “FOX”, associated with “The Simpsons” listing in selected cell 510 (FIG. 5). Similarly, metadata location 616 may correspond to the title of “The Simpsons” episode, e.g., “Kamp Krusty” in the listing in selected cell 510 (FIG. 5), metadata location 617 may correspond to the displayed day, e.g., Tuesday, for the listing in selected cell 510 (FIG. 5), metadata location 618 may correspond to the displayed time, e.g., 7 pm, for the listing in selected cell 510 (FIG. 5), while metadata location 619 may correspond to the displayed actor or voice actor, e.g., Hank Azaria, for the listing in selected cell 510 (FIG. 5).

Cell data structure 600 may include pointers P_615, P_616, . . . , P_620 associated with metadata locations 615-620, respectively. Each of pointers P_615, P_616, . . . , and P_620 may be associated with (or point to) other metadata locations within cell data structure 600, or be associated with or point to other pointers within cell data structure 600, or be associated with or point to metadata or pointers in other data structures. For instance, pointer P_615 may be associated with a video-on-demand listings structure that stores the available video-on-demand listings the correspond to the “FOX” channel associated with “The Simpsons” listing in a selected cell 510 (FIG. 5). Similarly, pointer P_616 may be associated with available video-on-demand listings that correspond to the title of “The Simpsons” episode, i.e., “Kamp Krusty”, e.g., video-on-demand listings “Krusty and Bart” or “Krusty Again!”.

Alternatively, pointer P_616 may be associated with the most viewed video-on-demand listings that are related to the title of “The Simpsons” episode, i.e., “Kamp Krusty”, e.g., video-on-demand listings PBS Sesame Street “Barney is a Clown”, and A&E 48 Hours “The Secret Town of Clownsville”. Pointer P_617 may be associated with or point to available video-on-demand listings for the day corresponding to the listing in selected cell 510 (FIG. 5), e.g., Tuesday, while pointer P_618 may be associated with or point to the available video-on-demand listings for the time corresponding to the listing in selected cell 510 (FIG. 5), e.g., 7 pm.

In general, pointers P_615 through P_620 may point to other suitable video-on-demand listings data structures, or to any suitable program grid listing cell data structures. In this manner, by accessing pointers P_615 through P_620, one may begin to construct a linked-list, e.g., of video-on-demand listings. The linked-list constructed in this manner would be related to the metadata in the cell data structure 600.

It will be evident to those skilled in the art that additional and/or alternative metadata and/or pointers corresponding to the selected program grid listing cell or an associated video-on-demand listing may be included in cell data structure 600.

FIG. 7 shows a data structure 700 that may be used to store information, e.g., metadata and pointers, corresponding to one or more available video-on-demand listings. The video-on-demand listings data structure may be stored in a storage device such as storage 308 (FIG. 3) in media guidance equipment 300 (FIG. 3). The metadata and pointers in data structure 700 may be correlated with contents of the cell data structure, e.g., structure 600 (FIG. 6), as will be described below in relation to FIGS. 7 and 9-12.

As with data structure 600, data structure 700 may be provided by media content source 416. Additionally, or alternatively, data structure 700 may be generated as required by processing circuitry 306 (FIG. 3), e.g., processing circuitry 306 (FIG. 3) may generate data structure 700 by retrieving and processing data stored in storage 308 (FIG. 3). Additionally, or alternatively, data structure 700 may be provided by media guidance data source 418 in media guidance system 400 (FIG. 4). In an embodiment, the cable system headend may be media content source 416 and may provide a video-on-demand listings data structure associated with the available video-on-demand listings that are to be transmitted to the user media equipment and/or the interactive media guidance application. This video-on-demand listings data structure may be stored on storage 308 (FIG. 3). At an appropriate time, e.g., when the VOD listing is to be displayed on an interactive display by the media guidance application, the video-on-demand listings data structure may then be retrieved from storage by processing circuitry 306 (FIG. 3). In an embodiment, the media guidance data source 418 may provide the video-on-demand listings data structure associated with each video-on-demand listing, and this data structure may be stored on storage 308 (FIG. 3). At an appropriate time, the VOD listings data structure may then be retrieved from storage by processing circuitry 306 (FIG. 3).

Data structure 700 includes alphanumeric identifiers 710 and 712. For example, for an available video-on-demand listing for the PBS children's program “Word World”, the identifier 710 may be “Word World”, while the identifier 712 may be the number 61273576, or any other suitable alphanumeric identifier. In an embodiment, identifier 712 is unique such that the metadata in data structure 700 may be uniquely identified and uniquely associated with an available video-on-demand listing, while identifier 710 may not be unique. The user of a unique identifier 712 allows for the differentiation between different video-on-demand listings. Data structure 700 also includes metadata locations 715-719 corresponding to the channel, title, actor, cumulative user rating for users who have viewed the video-on-demand program, and the number of views for the video-on-demand program across all video-on-demand users, all for the video-on-demand listing 710. Continuing with the “Word World” example, metadata location 715 may correspond to the channel, e.g., “PBS”, associated with “Word World”, metadata location 716 may correspond to the title of the “Word World” episode, e.g., “D is for Duck”, and metadata location 717 may correspond to an actor or voice in “Word World”.

Metadata location 718 in data structure 700 may correspond to the cumulative or aggregate user rating for users who have viewed the video-on-demand listing. For instance, if each user who views the “Word World” video-on-demand listing rates the listing on a scale of 1-5, metadata 718 may include an average, median, or mode of the cumulative, i.e., current total of the ratings. Metadata location 719 may correspond to the total number of users who have viewed the video-on-demand listing. For instance, if 700 users have viewed this video-on-demand listing, then metadata location 718 would include the number 700. Metadata location 718 may correspond to the cumulative user rating for users who have viewed the video-on-demand program. For instance, if 700 users have viewed this video-on-demand program, then metadata location 718 would include the number 700.

Video-on-demand listings data structure 600 may also include pointers P_715, P_716, . . . , P_720 corresponding to metadata locations 715-720, respectively. Each of pointers P_715, P_716, . . . , and P_720 may be associated with (or point to) other metadata locations within VOD listings structure 700, or be associated with or point to other pointers within VOD listings structure 700, or be associated with or point to metadata or pointers in other data structures, e.g., cell data structure 600. For instance, pointer P_715 may be associated with a video-on-demand listings structure that stores the available video-on-demand listings that correspond to the “PBS” channel associated with “Word World”.

In general, pointers P_715 through P_720 may point to any suitable video-on-demand listings data structures, or to any suitable program grid listing cell data structures. In this manner, by accessing pointers P_715 through P_720, one may begin to construct a linked-list, e.g., of video-on-demand listings. The linked-list constructed in this manner would be related to the metadata in the VOD listings data structure 700.

It will be evident to those skilled in the art that additional and/or alternative metadata corresponding to the selected program grid listing cell may be included in VOD listings structure 700.

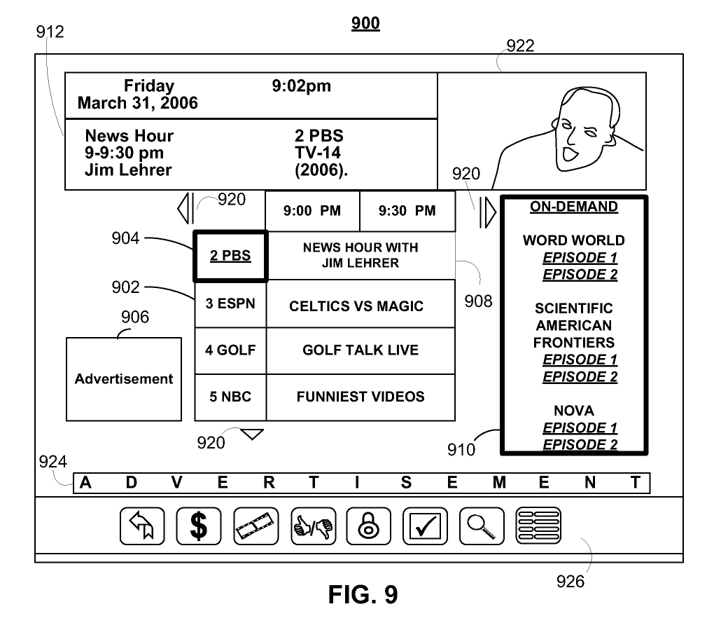

In order to display video-on-demand listings based on the metadata stored in data structures such as 600 (FIG. 6) and 700 (FIG. 7), an interactive media guidance application may provide a user an opportunity to select preferences for the display of these listings. The entry of these user preferences is described now in relation to FIGS. 8A and 8B.

FIGS. 8A and 8B show illustrative interactive displays 800 and 850, respectively, which may be used to enter user preferences related to the display of video-on-demand listings in an interactive media guidance application. Display 800 may be a display such as display 312 in FIG. 3, and may be generated in conjunction with processing circuitry, e.g., processing circuitry 306 in FIG. 3, by any suitable means, including a user selecting the “user preferences” button 202 in the display 200 (FIG. 2).

Display 800 presents a user with the opportunity to uniquely identify themselves using a pre-selected username 820 and password 830. The username and password may include any suitable alphanumeric characters. As there may be multiple users of a media guidance application in a particular location, this identification allows a user to select and save only their video-on-demand display preferences in a storage device on the media guidance equipment, e.g., storage 308 (FIG. 3) in FIG. 3. Once a user has successfully authenticated their entity to the media guidance application, e.g., by selecting authentication button 840 or by pressing a button on a user interface device, e.g., device 310 in FIG. 3, such as a remote control, the user is presented with display 850.

Display 850 includes selection opportunities 870, 880, 890, and 892. In an embodiment, selection 870 may allow a user to select if they would like to view video-on-demand listings when they select a cell in a program grid listing. If a user selects “Yes” as shown in display 850, video-on-demand listings will be displayed each time the user selects a cell in a program grid listing. This selection may be changed by the user providing an appropriate input from a user interface device, e.g., device 310 in FIG. 3. In an embodiment, selection 880 may allow a user to select the number of video-on-demand listings they would like to view when they select a cell in a program grid listing. This number may be incremented or decremented by the user providing an appropriate selection from a user interface device, e.g., device 310 in FIG. 3. In an embodiment, selection 890 may allow a user to select the type of video-on-demand listings they would like to view when they select a cell in a program grid listing. In an embodiment, a user may select to view video-on-demand listings for the channel corresponding to the selected program grid listing cell. In an embodiment, a user may select to view video-on-demand listings related to the content of the selected program grid listing cell. In an embodiment, a user may select to view the highest rated video-on-demand listings related to the content of the selected program grid listing cell. In an embodiment, a user may select to view the most viewed video-on-demand listings related to the selected program grid listing. Each of these selections may be changed by the user providing an appropriate selection from a user interface device, e.g., device 310 in FIG. 3.

Once the user has completed their selections, they may save their preferences by selecting save and return button 894, or by pressing a button on a user interface device, e.g., device 310 in FIG. 3, such as a remote control. The user preferences may then be stored on a storage device in the media guidance equipment, e.g., storage 308 (FIG. 3).

In an embodiment, a user may not provide their preferences for displaying video-on-demand listings. The media guidance application may then use a “default” user preference, e.g., displaying VOD listings for the channel of the selected cell in the program grid listing, or any other suitable default preference.

In an embodiment, once a user has been authenticated through user logon 800, the interactive media guidance application may monitor user viewing of video-on-demand programs. This may allow the interactive media guidance application to build and store metadata associated with user viewing information, from which user preferences may be determined by the interactive media guidance application automatically.

In an embodiment, the interactive media guidance application may monitor user viewing of video-on-demand programs, without requiring a user logon and/or authentication. The video-on-demand viewing for all users that interact with the media guidance application may be monitored and aggregated to determine the user preferences for the display of video-on-demand listings.

Embodiments of video-on-demand listings displays will now be discussed with reference to FIGS. 9, 10A, and 10B.

FIG. 9 shows an interactive grid program listings display 900 arranged by time and channel that also enables access to different types of media content in a single display. Display 900 may be generated on display 312 of media guidance system 300 of FIG. 3 in conjunction with processing circuitry 306 (FIG. 3). Display 900 in FIG. 9 may include grid 902 which includes cells of program listings, such as the program listing 908 for “News Hour with Jim Lehrer”. With a user interface or device, a user can select program listings by moving highlight region (or cell) 904. Information relating to the program listing selected by highlight region (or cell) 904 may be provided in program information region 912. Region 912 may include, for example, the program title (“News Hour with Jim Lehrer”), the program description, the time the program is provided, the channel the program is provided on, and other desired information.

Display 900 may also include regions 910 and 922, advertisement region 924, and options region 926, as discussed in reference to FIGS. 1 and 2 above. Region 922 may allow the user to view and/or preview programs that are currently available, will be available, or were available to the user, or to view any other suitable content related to the program listings in grid 902. The content of regions 910 and 922 may correspond to, or be independent from, one of the listings displayed in grid 902.

In an embodiment, the interactive media guidance application used to create display 900 may also provide access to non-linear programming, e.g., video-on-demand listings. Video-on-demand listings may be displayed in grid 902, or in regions 922 and/or 910 of display 900 as described below in reference to FIGS. 3 and 9.

In an embodiment, a user interacting with display 900 may initiate the generation and display of video-on-demand listings. For instance, processing circuitry 306 (FIG. 3) of media equipment or system 300 may implement an interactive media guidance application. A user interacting with the media guidance application using a user interface device, e.g., device 310, may select a cell 904 in a program listings grid 902. This action may lead processing circuitry 306 (FIG. 3) to highlight cell 904 in grid 402 (“News Hour with Jim Lehrer (PBS)”). Processing circuitry 306 (FIG. 3) may then retrieve, from a storage device, e.g., storage 308 (FIG. 3), of the media guidance equipment 300, metadata (see, e.g., data structure 700 (FIG. 7)) corresponding to the available video-on-demand listings. Processing circuitry 306 (FIG. 3) may then retrieve, from a storage device, e.g., storage 308 (FIG. 3), metadata corresponding to the contents of the selected cell 904. For instance, as cell 904 contains a program “News Hour with Jim Lehrer (PBS)”, processing circuitry 306 (FIG. 3) of the media guidance application may retrieve metadata corresponding to this program (see, e.g., cell data structure 600 of FIG. 6), such as the host, Jim Lehrer, or the channel, PBS. The metadata heretofore described may be stored in and retrieved from a cell data structure in storage 308 (FIG. 3). The cell data structure may be similar to that described with reference to data structure 600 (FIG. 6).

If a user has specified their preferences for displaying VOD listings, these preferences may then be retrieved from a storage device in the media guidance equipment, e.g., storage 308 (FIG. 3). These preferences may include whether to display VOD listings, how many listings to display, and what type of listings to display, as described above in relation to FIGS. 8A-B. For instance, a user may have a preference for displaying video-on-demand listings related to the channel, PBS, of the selected or highlighted cell 904.

Processing circuitry 306 (FIG. 3) of the media guidance application may then correlate the metadata associated with selected cell 904 to the metadata associated with the available video-on-demand listings. In the case of the user having a preference for displaying video-on-demand listings related to the channel, this correlation would result in the generation of a listing of one or more PBS video-on-demand programs. The correlation itself may be performed by processing circuitry 306 (FIG. 3) using any suitable algorithm. For instance, using the user-preferred channel, e.g., PBS, processing circuitry 306 (FIG. 3) may perform a depth-first search, or breadth-first search, or use any other suitable search algorithm to determine which video-on-demand listings metadata corresponds to the user-preferred PBS channel.

Alternatively, or additionally, the correlation itself may be performed by processing circuitry 306 (FIG. 3) constructing a linked-list with available video-on-demand listings by accessing any suitable pointers and/or any suitable metadata in the cell data structure corresponding to the selected cell 904, and any suitable video-on-demand listings data structure that may be retrieved from storage 308 (FIG. 3). The cell data or video-on-demand listings data structures may be similar to structures 600 and 700 described in reference to FIGS. 6 and 7. For example, a cell data structure associated with cell 904 may contain metadata for the “PBS” channel. In this case, processing circuitry 306 (FIG. 3) of the media guidance application may create a linked-list by accessing a pointer associated with the PBS metadata to access or retrieve a video-on-demand listings structure from storage 308 (FIG. 3). This video-on-demand listings structure may include, e.g., the available video-on-demand listings for the PBS channel. The accessed PBS video-on-demand listings structure may in turn include metadata and/or pointers from which additional video-on-demand listings structures may be located and retrieved from storage 308 (FIG. 3). Note that the constructed linked-list itself is a data structure that may be stored on storage 308 (FIG. 3).

Processing circuitry 306 (FIG. 3) may then present the generated listing of PBS video-on-demand programs to the user, e.g., in display region 910 of display 900. FIG. 9 shows how region 910 may be populated with VOD listings for episodes of available video-on-demand listings for other PBS productions, such as Word World, Scientific American Frontiers, or Nova.

The user may then select one of the displayed VOD listings using user interface device 310 to get more information about the selected VOD listing and/or view the selected VOD listing. In an embodiment, information related to the selected VOD listing may be displayed in regions 912 and/or 922 of display 900. The display of the information about a specific VOD listing may be enabled by the user navigating the display 900 with controls 920, or by the user using one or more of the selectable options in options region 926, e.g., an option for selecting to have more information displayed about a selectable VOD listing.

The display of VOD listings, e.g., VOD listings in region 910 of display 900, in this manner is advantageous in many respects. A user interacting with the media guidance application display 900 is able to not only view a particular channel while browsing the listings in grid 902, but also view the available VOD listings for that channel. Existing electronic program guides or other media guidance applications do not allow concurrent viewing of a program listings grid 902 and a VOD listings region 910 corresponding to a selected cell 904 in the grid. The display of FIG. 9 can save a user a lot of time when browsing VOD listings, which may be of particular importance for a user interacting with the media guidance application via user equipment with a small screen, e.g., a mobile telephone or PDA.

Further illustrative embodiments for displaying video-on-demand listings will be described further in relation to FIGS. 3, 10A and 10B.

FIGS. 10A and 10B show interactive grid program listings displays 1000 and 1050, respectively, arranged by time and channel that also enables access to different types of media content in a single display. Displays 1000 and 1050 differ in the region 1060 in display 1050 displays different content than region 1010 in display 1060. Displays 1000 and 1050 may be generated on display 312 of media guidance system 300 of FIG. 3 in conjunction with processing circuitry 306 (FIG. 3). Display 1000 in FIG. 10A (or 1050 in FIG. 10B) may include grid 1002 which includes cells of program listings, such as program grid listing 1008 for a half-hour duration episode of “The Simpsons”. A user may select a program listing by moving highlight region with an input to a user interface device, e.g., device 310 in FIG. 3, to select cell 1004. Information relating to the program listing in selected cell 1004 may be provided in program information region 1012. Region 1012 may include, for example, the program title (The Simpsons “Kamp Krusty””), the program description, the time the program is provided, the channel the program is provided on, and other desired information.

Displays 1000 and 1050 may also include regions 1010 or 1060, region 1022, advertisement 1024, and options region 1026, as described above in relation to FIGS. 1, 2, 5, and 9. Region 1022 may allow the user to view and/or preview programs that are currently available, will be available, or were available to the user, or to view any other suitable content related to the program listings in grid 1002. The content of regions 1010 or 1060 and 1022 may correspond to, or be independent from, one of the listings displayed in grid 1002.

In an embodiment, the interactive media guidance application used to create display 1000 may also provide access to non-linear programming, e.g., video-on-demand listings. Video-on-demand listings may be displayed in grid 1002, or in regions 1022 and/or 1010 or 1060 of displays 1000 and 1050 as described below in reference to FIGS. 3, 10A, and 10B.

In an embodiment, a user interacting with display 1000 (or 1050) may initiate the generation and display of video-on-demand listings. For instance, processing circuitry 306 (FIG. 3) of media equipment or system 300 may implement an interactive media guidance application. A user interacting with the media guidance application using a user interface device, e.g., device 310, may select a cell 1004 in a program listings grid 1002. This action may lead processing circuitry 1006 to select or highlight cell 1004 in grid 1002 (“The Simpsons”).

Processing circuitry 306 (FIG. 3) may then retrieve, from a storage device, e.g., storage 308 (FIG. 3), of the media guidance equipment 300, metadata (see, e.g., data structure 700 of FIG. 7) corresponding to the available video-on-demand listings. Processing circuitry 306 (FIG. 3) may then retrieve, from a storage device, e.g., storage 308 (FIG. 3), metadata corresponding to the contents of the selected cell 1004. For instance, as cell 1004 contains a program “The Simpsons”, processing circuitry 306 (FIG. 3) of the media guidance application may retrieve metadata corresponding to this program (see, e.g., data structure 600 of FIG. 6), such as the title, “Kamp Krusty”, or the channel the program is provided on, FOX.

If a user has specified their preferences for displaying VOD listings, these preferences may then be retrieved from a storage device in the media guidance equipment, e.g., device 308. These preferences may include whether to display VOD listings, how many listings to display, and what type of listings to display, as described above in relation to FIGS. 8A and 8B. For instance, the user may indicate a preference for displaying video-on-demand listings related to a channel corresponding to a selected cell 1004, or for displaying video-on-demand listings related to the content of a program listing in a selected cell 1004, or for displaying the most highly rated video-on-demand listings related to the content of a program listing in the selected cell 1004, or for displaying the most viewed video-on-demand listings related to the content of a program listing in the selected cell 1004, or the user may indicate any other suitable user preference for displaying VOD listings, as described above in reference to FIGS. 8A and 8B.

In the embodiment of FIG. 10A, for instance, a user may have indicated a preference for displaying video-on-demand listings related to the content of the selected cell 904 (The Simpsons “Kamp Krusty”), the channel of the selected cell 904 (FOX), or the most highly-rated video-on-demand listings related to the content of the selected cell 904. In the embodiment of FIG. 10B, a user may have indicated a preference for displaying the most highly-rated or most viewed video-on-demand listings related to the content of the selected cell 904.

Processing circuitry 306 (FIG. 3) of the media guidance application may then correlate the metadata associated with selected cell 1004 to the metadata associated with the available video-on-demand listings. In the case of the user having a preference for displaying video-on-demand listings related to the content channel, this correlation would result in the generation of a listing of one or more video-on-demand programs that are related to “The Simpsons”, or “Kamp Krusty”, or any other metadata associated with selected cell 1004. The correlation itself may be performed by processing circuitry 306 (FIG. 3) using any suitable algorithm. For instance, using the user-selected preference for video-on-demand content related to the contents of the selected cell, processing circuitry 306 (FIG. 3) may perform a depth-first search, or breadth-first search, or use any other suitable search algorithm to determine which video-on-demand listings metadata corresponds to the metadata (e.g., “The Simpsons”, “Kamp Krusty”, “1992”, “7-7:30 pm”) associated with selected cell 1004. This metadata may be stored in and retrieved from a cell data structure in storage 308 (FIG. 3). The cell data structure may be similar to that described with reference to FIG. 6 above.

Alternatively, or additionally, the correlation itself may be performed by processing circuitry 306 (FIG. 3) constructing a linked-list with available video-on-demand listings by accessing any suitable pointers and/or any suitable metadata in the cell data structure corresponding to the selected cell 1004, and any suitable video-on-demand listings data structure that may be retrieved from storage 308 (FIG. 3) (FIG. 3). The cell data or video-on-demand listings data structures may be similar to structures 600 and 700 described in reference to FIGS. 6 and 7. For example, a cell data structure associated with cell 1004 may contain metadata for the “FOX” channel. In this case, processing circuitry 306 (FIG. 3) of the media guidance application may create a linked-list by accessing a pointer associated with the FOX metadata to access or retrieve a video-on-demand listings structure from storage 308 (FIG. 3). This video-on-demand listings structure may include, e.g., the available video-on-demand listings for the FOX channel. The accessed FOX video-on-demand listings structure may in turn include metadata and/or pointers from which additional video-on-demand listings structures may be located and retrieved from storage 308 (FIG. 3). In a similar manner, processing circuitry 306 (FIG. 3) may generate a linked-list of video-on-demand listings using the title of “The Simpsons” episode in selected cell 1004. The linked-list itself is a data structure that may be stored on storage 308 (FIG. 3).

In an embodiment, processing circuitry 306 (FIG. 3) may perform a correlation resulting in the generation of one or more video-on-demand listings for other episodes of “The Simpsons” that have titles that are related to the title of the selected “The Simpsons” episode, as illustrated in FIG. 10A. In an embodiment, the generated VOD listings may be a listing of the most viewed or most highly rated video-on-demand listings by users of the media guidance application, that are related to the “The Simpsons” “Kamp Krusty” program, as illustrated in FIG. 10B. In practice, any suitable information could be used to generate the video-on-demand listings, e.g., the actors in the program of the selected cell, the director of the program of the selected cell, and the year the program of the selected cell was released. In the illustrative embodiment of FIG. 10B, for instance, the media guidance application generates video-on-demand listings that are related to the content of the selected “The Simpsons” program listing, e.g., an “A&E” episode titled “The Secret of Clownsville” which is related to “Krusty” the clown in “The Simpsons” series. Thus, the generated VOD listings may not include other episodes of “The Simpsons”.

Processing circuitry 306 (FIG. 3) may present the generated listing of video-on-demand programs to the user, e.g., in display region 1010 of display 1000, or in display region 1060 of display 1050. The user may then select one of the displayed VOD listings using user interface device 310 to get more information about the selected VOD listing and/or view the selected VOD listing. In an embodiment, information related to the selected VOD listing may be displayed in regions 1012 and/or 1022 of displays 1000 or 1050. For instance, regions 1010 and/or 1060 may be populated with VOD listings related to “The Simpsons” episode, as shown in FIGS. 10A and 10B, respectively.

The display of VOD listings, e.g., VOD listings in region 1010 of display 1000 or region 1050 of display 1050, in this manner is advantageous in many respects. Existing electronic program guides or other media guidance applications do not display VOD listings that are related to the content of the selected cell. The displays of FIGS. 9, 10A and 10B can save a user a lot of time when browsing VOD listings, which may be of particular importance for a user interacting with the media guidance application via user equipment with a small screen, e.g., a mobile telephone or PDA.

The following flow charts serve to illustrate processes involved in some embodiments of this invention. The flow charts describe processes primarily in the context of displaying video-on-demand listings based at least in part on user preferences and/or based at least in part on the user's selection of a cell in the display of an interactive media guidance application. It will be understood that each step in these flow charts may be carried out by the interactive media guidance application by executing instructions on processing circuitry 306 (FIG. 3).

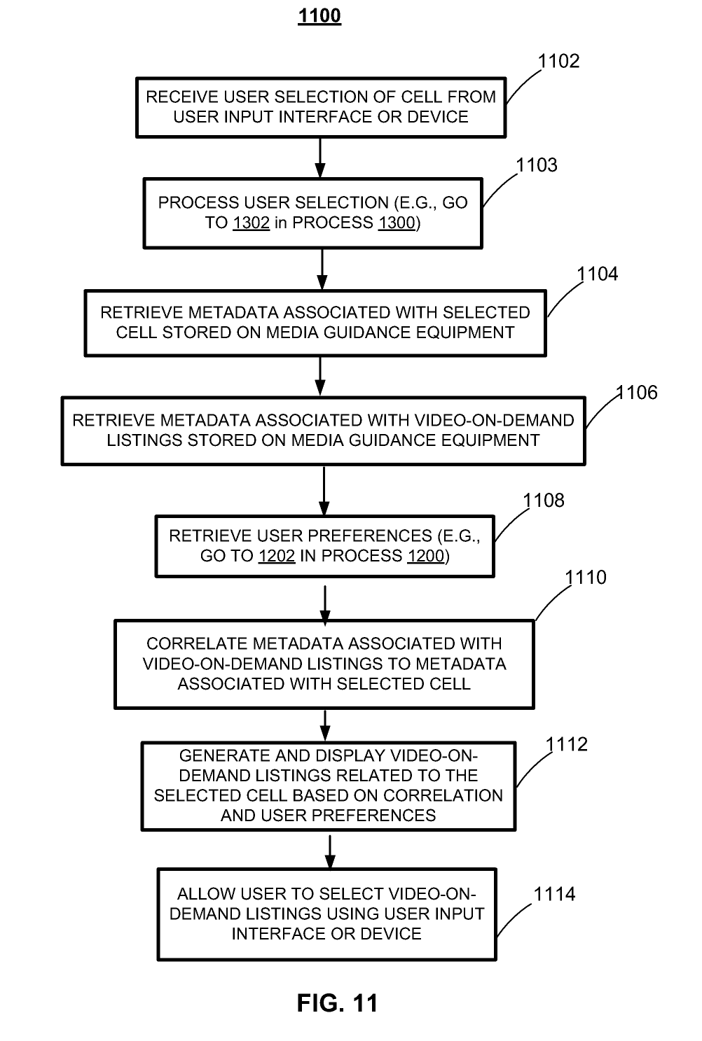

FIG. 11 is a process flow diagram for process 1100 for the display of video-on-demand listings according to an illustrative embodiment. The steps shown in FIG. 11 are only illustrative and in general may be performed in any order. In addition, some of the steps shown in FIG. 11 may be optional.

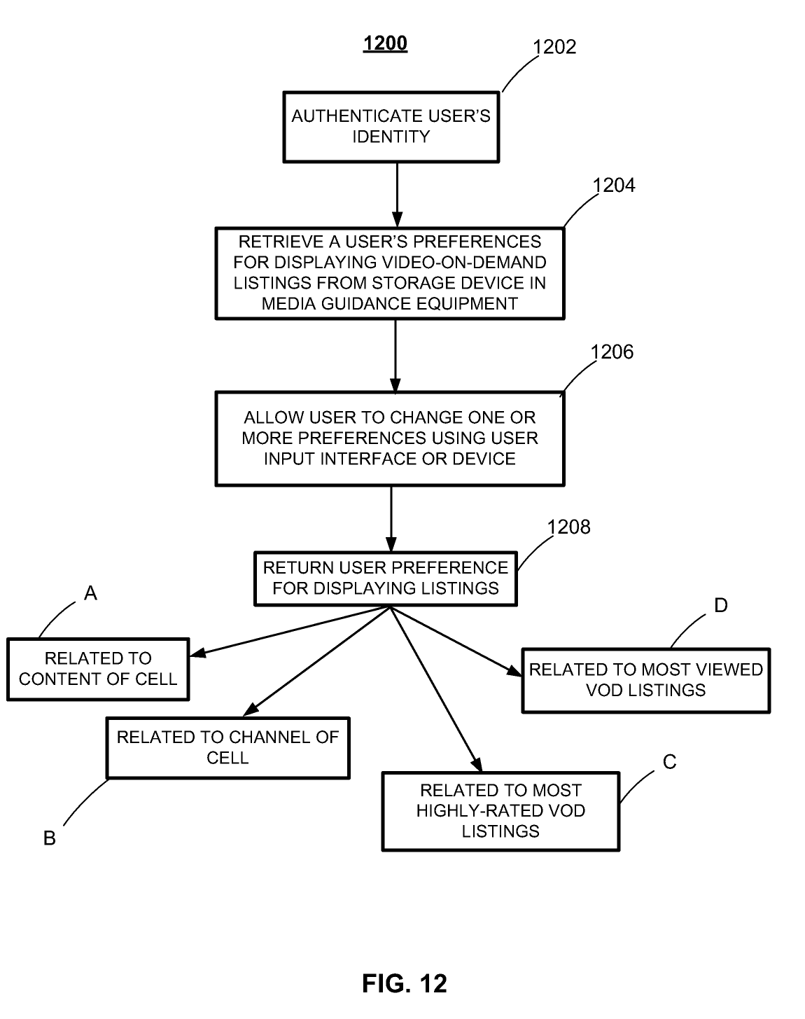

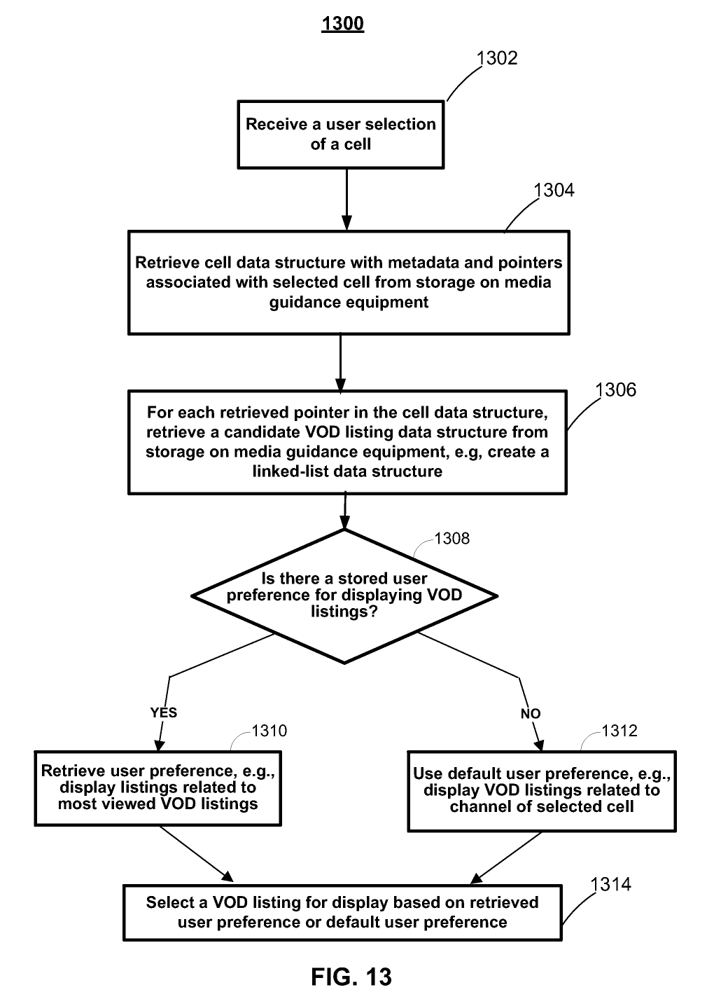

With reference to FIGS. 3, 9 and 11, process 1100 begins with processing circuitry 306 (FIG. 3) receiving a user input selecting a cell in the program grid listing (step 1102), e.g., a user selecting cell 904 (“News Hour with Jim Lehrer”) in FIG. 9. Processing circuitry 306 (FIG. 3) then processes the user's selection of the cell (step 1103), e.g., cell 904 in FIG. 9. The processing of the user's selection of the cell may be carried out as described below in reference to the decision tree diagram in FIG. 13. Processing circuitry 306 (FIG. 3) retrieves the metadata associated with the selected cell from storage device 308 (step 1104), e.g., with cell 904 in FIG. 9, the metadata may be “Jim Lehrer” or “PBS”. Processing circuitry 306 (FIG. 3) then retrieves the metadata associated with the available video-on-demand listings from storage device 308 (step 1106). User preference information is then retrieved from storage device 308 (step 1108). User preference information may be retrieved using the process 1200 of FIG. 12 described below. For instance, a user may have expressed a preference for displaying VOD listings related to the channel of the selected cell 904, e.g., PBS. Processing circuitry 306 (FIG. 3) may then correlate the metadata associated with selected cell 904 to the metadata associated with the available video-on-demand listings (step 1110), e.g., PBS video-on-demand listings may be correlated to the metadata PBS associated with cell 904. The correlation performed may result in the generation and display of a listing of PBS video-on-demand programs (step 1112), e.g., in region 910 in display 900. Finally, process 1100 ends with the step 1114 of allowing user to select a video-on-demand listing.

As described above with relation to FIGS. 6-7, 9, 10A, and 10B, the generation of the video-on-demand listings may include the construction of a linked-list from the pointers and/or metadata retrieved from any suitable combination of cell and/or video-on-demand listings data structures. The linked-lists may be stored on storage 308 (FIG. 3).

FIG. 12 is a process flow diagram for process 1200 for the retrieval of user preferences pertaining to the display of video-on-demand listings according to an illustrative embodiment. The steps shown in FIG. 12 are only illustrative and in general may be performed in any order. In addition, some of the steps shown in FIG. 12 may be optional.

With reference to FIGS. 8A, 8B, and 12, process 1200 begins with processing circuitry 306 (FIG. 3) authenticating the identity of a user interacting with the media guidance application (step 1202), e.g., a user logging on to the user preference logon 800 with a pre-selected username and password. If the user had previously selected preferences for the display of video-on-demand listings, these preferences are then retrieved by processing circuitry 306 (FIG. 3) from storage 308 (FIG. 3) (step 1204). If a user had not previously selected preferences for the display of video-on-demand listings, or if a user would like to change their retrieved preferences, processing circuitry allows the user to enter these preferences, e.g., using preference screen 850 (step 1206). Process 1200 concludes with the return of the user preferences for displaying video-on-demand listings, e.g., (A) relating to the content of the selected cell, e.g., cell 904 in FIG. 9, (B) relating to the channel of the selected cell, e.g., cell 904 in FIG. 9, (C) relating to the most highly-rated video-on-demand listings related to the content of the selected cell, e.g., cell 904 in FIG. 9, or (D) relating to the most viewed video-on-demand listings related to the content of the selected cell, e.g., cell 904 in FIG. 9. In practice, any other suitable preference may be retrieved or returned as described in relation to FIGS. 8A and 8B.

FIG. 13 is a decision tree diagram for the processing of a user selection of a cell in a program listings grid according to an illustrative embodiment. The steps shown in FIG. 13 are only illustrative and in general may be performed in any order. In addition, some of the steps shown in FIG. 13 may be optional.

With reference to FIGS. 3, 9 and 11, decision tree 1300 begins with processing circuitry 306 (FIG. 3) (which may be used to implement an interactive media guidance application) receiving a user's selection of a cell in the program grid listing (step 1302). For instance, a user may have selected cell 904 (“News Hour with Jim Lehrer”) in FIG. 9. Once the selection of a cell is received, processing circuitry 306 (FIG. 3) retrieves a cell data structure, including metadata and pointers, associated with the selected cell from storage 308 (FIG. 3) off the media guidance equipment (step 1304). Cell data structure may be similar to data structure 600 described above in relation to FIG. 6. For instance, processing circuitry 306 (FIG. 3) may retrieve metadata corresponding to the “News Hour” program such as the host, Jim Lehrer, or the channel, PBS, and pointers associated with video-on-demand listings related to Jim Lehrer, and to PBS.

For each retrieved pointer in the cell data structure, a VOD listing data structure, or candidate VOD listing, is retrieved and stored in storage 308 (FIG. 3) (step 1306). The VOD listing may be created by accessing the metadata and/or pointers associated with the retrieved pointers, thereby creating another data structure such as a linked-list, as described above in relation to FIGS. 6 and 7. For instance, processing circuitry 306 (FIG. 3) may retrieve a VOD listings data structure with the available PBS video-on-demand listings, or the video-on-demand listings associated with Jim Lehrer.

Processing circuitry 306 (FIG. 3) of the media guidance application then checks to see if there is a stored user preference for displaying VOD listings in storage 308 (FIG. 3) (step 1308). If there is a user preference, it is retrieved from storage 308 (FIG. 3), e.g., as described in relation to process 1200 in FIG. 12 (step 1310). For instance, a user may have a preference for displaying video-on-demand listings related to the channel, PBS, of the selected or highlighted cell 904, and including no more than 2 such listings in the generated VOD listings display. If there is no stored user preference for displaying VOD listings, then a default user preference is retrieved from storage 308 (FIG. 3), e.g., as described in relation to process 1200 in FIG. 12 (step 1312). For instance, the default user preference may be to display the 3 most-viewed video-on-demand listings related to the currently selected cell. Finally, at step 1314, processing circuitry 306 (FIG. 3) selects a VOD listing for display based on retrieved user preference (step 1314).

The above described embodiments are presented for purposes of illustration and not of limitation, and the present invention is limited only by the claims which follow. For example, it will be appreciated that while the discussion of media content has focused on video content, the principles of media guidance can be applied to other types of media content, such as music, images, etc.

What is claimed is:

1. A method for providing video-on-demand listings in an interactive display provided by an interactive media guidance application implemented on media guidance equipment comprising:
receiving a user selection of a cell in a program listings grid in a first region of the interactive display;
retrieving data from a storage device in the media guidance equipment, wherein the data is associated with the selected cell;
generating video-on-demand listings related to the selected cell based on the retrieved data;
displaying the generated video-on-demand listings in a second region of the interactive display; and
allowing the user to select one of the video-on-demand listings for viewing.

2. The method of claim 1, wherein the generated video-on-demand listings include one or more video-on-demand listings for the channel corresponding to the selected cell.

3. The method of claim 1, wherein the generated video-on-demand listings include the highest rated video-on-demand (VOD) listings related to the content of the program listing in the selected cell, wherein the highest rated VOD listings include one of listings with the largest cumulative audience rating and listings that have been selected by the largest number of media guidance application users.

4. The method of claim 1, wherein the generated video-on-demand listings include the most viewed video-on-demand listings related to the content of the program listing in the selected cell.

5. The method of claim 1, further comprising displaying the selected video-on-demand listing on the interactive display.

6. The method of claim 1, further comprising retrieving a user preferences for the interactive media guidance application from the media guidance equipment.

7. The method of claim 6, wherein the video-on-demand listings are generated based in part on the user preferences retrieved from the media guidance equipment.

8. The method of claim 6, wherein the user preferences include at least one of displaying video-on-demand listings related to a channel corresponding to the selected cell, displaying video-on-demand listings related to the content of a program listing in the selected cell, displaying the highest rated video-on-demand listings related to the content of a program listing in the selected cell, and displaying the most viewed video-on-demand listings related to the content of a program listing in the selected cell.

9. The method of claim 6, wherein the user preferences are stored on the media guidance equipment by allowing the user to input the user preferences when interacting with the media guidance application.

10. The method of claim 6, wherein the user preferences are stored on the media guidance equipment by having the media guidance application monitor the user interactions with the interactive media guidance application to determine one or more of the user preferences.

11. The method of claim 1, wherein the data is correlated by associating data corresponding to the metadata associated with the selected cell to metadata associated with the available video-on-demand listings.

12. The method of claim 11, wherein the data is associated using a pointer from the metadata associated with the selected cell to the metadata associated with the available video-on-demand listings.

13. The method of claim 11, wherein the data corresponding to the contents of the selected cell are stored in a data structure in a storage device in the media guidance equipment.

14. The method of claim 11, wherein the data corresponding to the available video-on-demand listings are stored in a data structure in a storage device in the media guidance equipment.

15. A media guidance system for providing video-on-demand listings comprising:
an interactive display provided by an interactive media guidance application implemented on media guidance equipment, the interactive media guidance application configured to:
receive a user selection of a cell in a program listings grid in a first region of the interactive display;
retrieving data from a storage device in the media guidance equipment, wherein the data is associated with to the selected cell;
generate video-on-demand listings related to the selected cell based on the retrieved data;
display the generated video-on-demand listings in a second region of the interactive display; and
allow the user to select one of the video-on-demand listings for viewing.

16. The media guidance system of claim 15, wherein the generated video-on-demand listings include one or more video-on-demand listings for the channel corresponding to the selected cell.

17. The media guidance system of claim 15, wherein the generated video-on-demand listings include the highest rated video-on-demand listings related to the content of the program listing in the selected cell, wherein the highest rated VOD listings include one of listings with the largest cumulative audience rating and listings that have been selected by the largest number of media guidance application users.

18. The media guidance system of claim 15, wherein the generated video-on-demand listings include the most viewed video-on-demand listings related to the content of the program listing in the selected cell.

19. The media guidance system of claim 15, further comprising displaying the selected video-on-demand listing on the interactive display.

20. The media guidance system of claim 15, wherein the interactive media guidance application is further configured to retrieve a user preferences for the interactive media guidance application from the media guidance equipment.

21. The media guidance system of claim 20, wherein the interactive media guidance application generates the video-on-demand listings based in part on the user preferences retrieved from the media guidance equipment.

22. The media guidance system of claim 21, wherein the user preferences include at least one of displaying video-on-demand listings related to a channel corresponding to the selected cell, displaying video-on-demand listings related to the content of a program listing in the selected cell, displaying the highest rated video-on-demand listings related to the content of a program listing in the selected cell, and displaying the most viewed video-on-demand listings related to the content of a program listing in the selected cell.

23. The media guidance system of claim 20, wherein the user preferences are stored on the media guidance equipment by allowing the user to input the user preferences when interacting with the media guidance application.

24. The media guidance system of claim 23, wherein the user preferences are stored on the media guidance equipment by having the media guidance application monitor the user interactions with the interactive media guidance application to determine one or more of the user preferences.

25. The media guidance system of claim 15, wherein the interactive media guidance application correlates the data by associating data corresponding to the contents of the selected cell to data corresponding to the available video-on-demand listings.

26. The media guidance system of claim 25, wherein the data is associated using a pointer from the metadata associated with the selected cell to the metadata associated with the available video-on-demand listings.

27. The media guidance system of claim 25, wherein the data corresponding to the contents of the selected cell are stored in a data structure in a storage device in the media guidance equipment.

28. The media guidance system of claim 25, wherein the data corresponding to the available video-on-demand listings are stored in a data structure in a storage device in the media guidance equipment.

29. A system for providing video-on-demand listings in an interactive display provided by an interactive media guidance application implemented on media guidance equipment comprising:
means for receiving a user selection of a cell in a program listings grid in a first region of the interactive display;
means for retrieving data from a storage device in the media guidance equipment, wherein the data is associated with the selected cell;
means for generating video-on-demand listings related to the selected cell based on the retrieved data;
means for displaying the generated video-on-demand listings in a second region of the interactive display; and
means for allowing the user to select one of the video-on-demand listings for viewing.

30. The system of claim 29, wherein the generated video-on-demand listings include one or more video-on-demand listings for the channel corresponding to the selected cell.

31. The system of claim 29, wherein the generated video-on-demand listings include the highest rated video-on-demand (VOD) listings related to the content of the program listing in the selected cell, wherein the highest rated VOD listings include one of listings with the largest cumulative audience rating and listings that have been selected by the largest number of media guidance application users.

32. The system of claim 29, wherein the generated video-on-demand listings include the most viewed video-on-demand listings related to the content of the program listing in the selected cell.

33. The system of claim 29, further comprising means for displaying the selected video-on-demand listing on the interactive display.

34. The system of claim 29, further comprising means for retrieving a user preferences for the interactive media guidance application from the media guidance equipment.

35. The system of claim 34, wherein the video-on-demand listings are generated based in part on the user preferences retrieved from the media guidance equipment.

36. The system of claim 34, wherein the user preferences include at least one of displaying video-on-demand listings related to a channel corresponding to the selected cell, displaying video-on-demand listings related to the content of a program listing in the selected cell, displaying the highest rated video-on-demand listings related to the content of a program listing in the selected cell, and displaying the most viewed video-on-demand listings related to the content of a program listing in the selected cell.

37. The system of claim 34, wherein the user preferences are stored on the media guidance equipment by allowing the user to input the user preferences when interacting with the media guidance application.

38. The system of claim 34, wherein the user preferences are stored on the media guidance equipment by having the media guidance application monitor the user interactions with the interactive media guidance application to determine one or more of the user preferences.

39. The system of claim 29, wherein the data is correlated by associating data corresponding to the metadata associated with the selected cell to metadata associated with the available video-on-demand listings.

40. The system of claim 39, wherein the data is associated using a pointer from the metadata associated with the selected cell to the metadata associated with the available video-on-demand listings.

41. The system of claim 39, wherein the data corresponding to the contents of the selected cell are stored in a data structure in a storage device in the media guidance equipment.

42. The system of claim 39, wherein the data corresponding to the available video-on-demand listings are stored in a data structure in a storage device in the media guidance equipment.
